(19) United States
(12) Patent Application Publication
(10) Pub. No.: US 2007/0173129 A1
(43) Pub. Date: Jul. 26, 2007

(54) CONNECTOR

(75) Inventor: Qing Song Han, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/625,231

(22) Filed: Jan. 19, 2007

(30) Foreign Application Priority Data
Jan. 20, 2006 (TW) TW95102196

(51) Int. Cl. H01R 24/00

(52) U.S. Cl. 439/660

(57) ABSTRACT

A connector. The connector includes a USB socket and a USB plug. The USB plug is detachably connected with the USB socket. When the USB plug is connected to the USB socket, a closed space is formed by the USB plug and the USB socket, which prevents static discharge being occurred.

### BACKGROUND OF THE INVENTION

1. Field of the Invention

The invention relates to a connector, and in particular, to a connector which enables connection of a plug and a socket in a closed space.

2. Description of the Related Art

FIG. 1 is a side view of a conventional USB (Universal Serial Bus) connector 1, comprising a USB socket 2 and a USB plug 3. The USB plug 3 comprises a metallic plug 4 and the USB socket 2 comprises a socket aperture 5. When the metallic plug 4 is inserted into the socket aperture 5 of the USB socket 2, the metallic plug 4 is not inserted securely or cannot insert closely into the socket aperture 5 because of low precision. Thus, part of the metallic plug 4 is exposed to the external air. When static charge builds up, static discharge occurs on the metallic plug 4 and the electronic device is affected. Thus, the electronic device may be damaged.

### BRIEF SUMMARY OF THE INVENTION

A connector with particular USB plug and USB socket structures, capable of preventing static discharge, is provided. Accordingly, an exemplary embodiment of a connector comprises a USB socket and a USB plug. The USB plug is detachably connected to the USB socket. When the USB plug is connected to the USB socket, a closed space is formed by the USB plug and the USB socket.

The USB plug further comprises a metallic plug and an insulating portion. The metallic plug is electrically connected to the USB socket, and comprises a first connecting part. The insulating portion covers the metallic plug. The USB socket further comprises a cable, which is electrically connected to the metallic plug. The USB socket comprises an insulating case and a second connecting part. The insulating case comprises an extended part. The second connecting part is disposed in the insulating case. When the USB plug is inserted into the USB socket, the first connecting part is engaged with the second connecting part and the extended part abuts the insulating portion, to form a closed space. The first connecting part and the second connecting part respectively comprise a plurality of metallic contacts, when the first connecting part is engaged with the second connecting part, the metallic contacts of the first connecting part are electrically connected to the metallic contacts of the second connecting part.

Alternatively, the USB plug comprises an insulating portion and a metallic plug. The insulating portion comprises an extended part. The metallic plug is disposed in the insulating portion, and comprises a first connecting part. The first connecting part is electrically connected with the USB socket. The USB socket comprises an insulating case and a second connecting part. The second connecting part is disposed in the insulating case. When the USB plug is inserted into the USB socket, the first connecting part of the metallic plug is engaged with the second connecting part and the extended part of the insulating portion abuts the insulating case, to form a closed space. The USB plug further comprises a cable, which is electrically connected with the metallic plug. The first connecting part and the second connecting part respectively comprise a plurality of metallic contacts, when the first connecting part is engaged with the second connecting part, the metallic contacts of the first connecting part are electrically connected with the metallic contacts of the second connecting part.

Alternatively, the USB plug comprises an insulating portion and a metallic plug. The insulating portion comprises a first extended part. The metallic plug is disposed in the first extended part, and comprises a first connecting part. The first connecting part is connected to the USB socket. The USB socket comprises an insulating case and a second connecting part. The insulating case comprises a second extended part. The second connecting part is disposed in the insulating case. When the USB plug is inserted into the USB socket, the first connecting part is engaged with the second connecting part and the first extended part is engaged with the second extended part, to form a closed space. The first extended part further comprises a narrow part and the second extended part comprises a narrow space, when the USB plug is inserted into the USB socket, the first connecting part is engaged with the second connecting part, and the narrow part of the first connecting part is engaged with the narrow space of the second connecting part.

Note that the USB plug further comprises a cable, which is electrically connected with the metallic plug. The first connecting part and the second connecting part respectively comprise a plurality of metallic contacts, wherein when the first connecting part is engaged with the second connecting part, the metallic contacts of the first connecting part are electrically connected with the metallic contacts of the second connecting part.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional USB connector;

FIG. 2 is an exploded schematic view of a first embodiment of a USB connector;

FIG. 3 is a schematic view of a USB plug inserted into a USB socket in FIG. 2;

FIG. 4 is another schematic view of the USB connector in FIG. 2;

FIG. 5 is an exploded schematic view of a second embodiment of a USB connector;

FIG. 6 is a schematic view of a USB plug inserted into a USB socket in FIG. 5;

FIG. 7 is an exploded schematic view of a third embodiment of a USB connector;

FIG. 8 is a schematic view of a USB plug inserted into a USB socket in FIG. 7;

FIG. 9 is an exploded schematic view of a fourth embodiment of a USB connector; and

FIG. 10 is a schematic view of a USB plug inserted into a USB socket in FIG. 9.

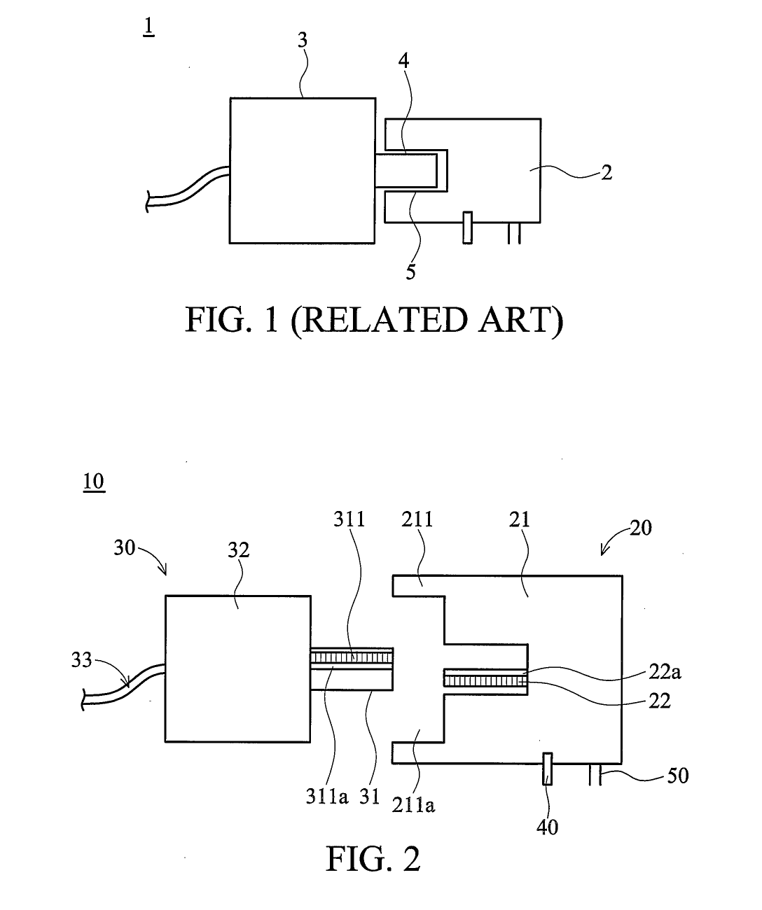

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

Referring to FIG. 2, a first embodiment of a connector 10 comprises a USB socket 20 and a USB plug 30. The USB plug 30 is detachably connected with the USB socket 20. The USB plug 30 comprises a metallic plug 31, an insulating portion 32 and a cable 33. The metallic plug 31 is electrically connected with the USB socket 20, and comprises a first connecting part 311. The first connecting part 311 comprises four metallic contacts 311a (as shown in FIG. 4). The insulating portion 32 covers the metallic plug 31. The cable 33 is electrically connected with the metallic plug 31.

The USB socket 20 comprises an insulating case 21 and a second connecting part 22. The insulating case 21 comprises an extended part 211 and a space 211a formed by the extended part 211. The second connecting part 22 is disposed in the insulating case 21, and comprises four metallic contacts 22a. The USB socket 20 further connects to two ground pins 40 (FIG. 2 is a side view which shows only one ground pin) to guide excess currents or noise to the ground. Additionally, the USB socket 20 uses four solder pins 50 for welding on any electronic device. (FIG. 2 is a side view which shows only two solder pins).

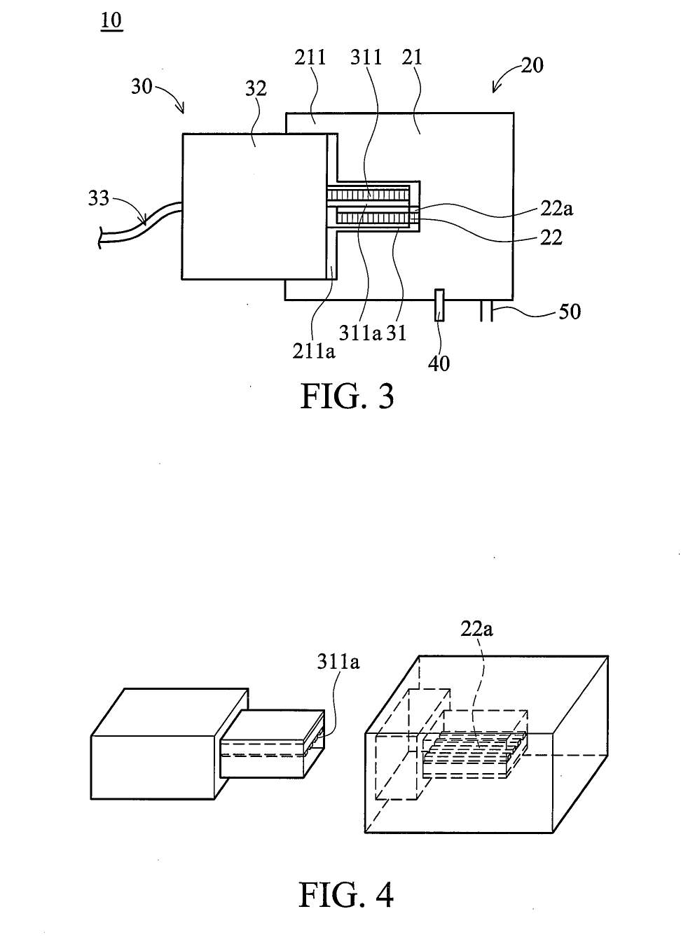

Referring to FIG. 3, when the USB plug 30 is inserted into the USB socket 20, the first connecting part 311 is engaged with the second connecting part 22, thus the metallic contacts 311a of the first connecting part 311 are electrically connected to the metallic contacts 22a of the second connecting part 22 for data transfer. The extended part 211 of the USB socket 20 abuts the insulating portion 32 of the USB plug 30. In other words, the insulating portion 32 is closely connected to the space 211a inside the insulating case 211, thus the USB plug 30 and the USB socket 20 form a closed space to protect the electronic device from damage by static discharge through the metallic plug 31. Parts of the space 211a is remained if the USB plug 30 and the USB socket 20 are not closely connected, as shown in FIG. 3, the metallic plug 31 can still be separated from external air due to surrounded by the insulating portion 32 and the insulating case 21, which easily prevents static discharge.

### Second Embodiment

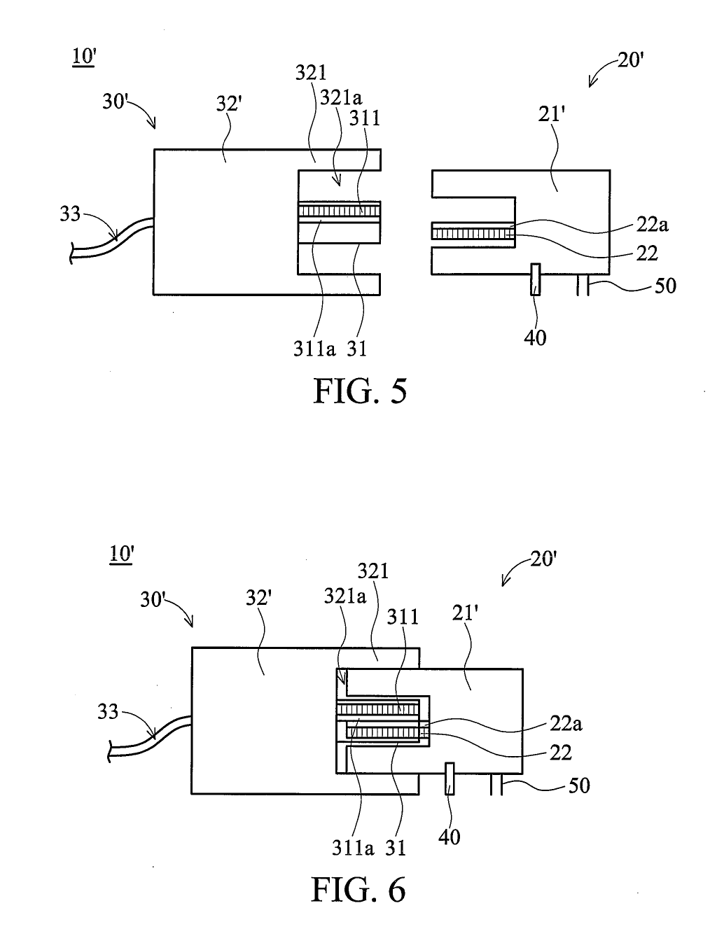

Referring to FIG. 5, most of the structures in a second embodiment of a USB connector 10′ are similar to those in the first embodiment, except for an insulting portion 32′ of USB plug 30′ and insulting case 21′ of USB socket 20′. In detail, the insulating portion 32′ comprises an extended part 321 and a space 321a formed by the extended part 321. Furthermore, the insulting case 21′ of the USB socket 20′ has neither the extended part 211 nor the space 211a of the first embodiment.

Thus, when the USB plug 30′ is inserted into the USB socket 20′, the first connecting part 311 is engaged with the second connecting part 22, thus the metallic contacts 311a of the first connecting part 311 are electrically connected to the metallic contacts 22a of the second connecting part 22 for data transfer. The extended part 321 of the USB plug 30′ abuts the insulating case 21′. In other words, the insulating case 21′ is closely connected to the space 321a inside the insulating portion 32′, so that the USB plug 30′ and the USB socket 20′ form a closed space to protect the electronic device from damage by static discharge through the metallic plug 31. Parts of the space 321a is remained if the USB plug 30′ and the USB socket 20′ are not closely connected, as shown in FIG. 6, the metallic plug 31 can still be separated from external air due to surrounded by the insulating portion 32′ and the insulating case 21′, which easily prevents static discharge.

### Third Embodiment

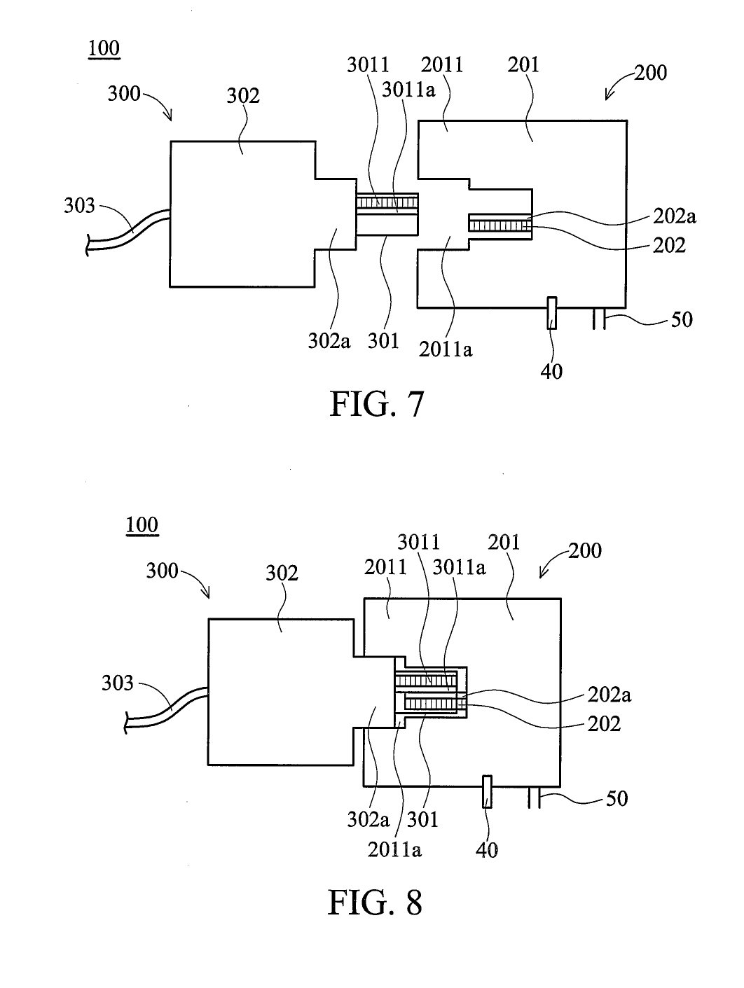

Referring to FIG. 7, a third embodiment of a USB connector 100 comprises a USB socket 200 and a USB plug 300. The USB plug 300 is detachably connected with the USB socket 200. The USB plug 300 comprises a metallic plug 301, an insulating portion 302 and a cable 303. The metallic plug 301 is electrically connected to the USB socket 200, and comprises a first connecting part 3011.

The first connecting part 3011 comprises four metallic contacts 3011a (the same with those described in the first and second embodiments, as shown in FIG. 4). The insulating portion 302 covers the metallic plug 301, and comprises a first extended part 302a. The cable 303 is electrically connected to the metallic plug 301. The USB socket 200 comprises an insulating case 201 and a second connecting part 202. The insulating case 201 comprises a second extended part 2011 and a space 2011a formed by the second extended part 2011. The second connecting part 202 is disposed in the insulating case 201, and comprises four metallic contacts 202a. Furthermore, the USB socket 200 connects with two ground pins 40 (FIG. 7 is a side view which shows only one ground pin) to guide excess currents or noise to the ground. Additionally, the USB socket 200 uses four solder pins 50 to weld on any electronic device. (FIG. 7 is a side view which shows only two solder pins).

Referring to FIG. 8, when the USB plug 300 is inserted into the USB socket 200, the first connecting part 3011 is engaged with the second connecting part 202, thus the metallic contacts 3011a of the first connecting part 3011 are electrically connected with the metallic contacts 202a of the second connecting part 202 for data transfer. The first extended part 302a of the USB plug 300 abuts the second extended part 2011 of the USB socket 200. The first extended part 302a of the insulating portion 302 is closely connected to the second extended part 2011 of the insulating case 201, thus the USB plug 300 and the USB socket 200 form a closed space to protect the electronic device from damage by static discharge through the metallic plug 301. Parts of the space 2011a is remained if the USB plug 300 and the USB socket 200 are not closely connected, the metallic plug 301 can still be separated from external air due to surrounded by the insulating portion 302 and the insulating case 201, which easily prevents static discharge.

### Fourth Embodiment

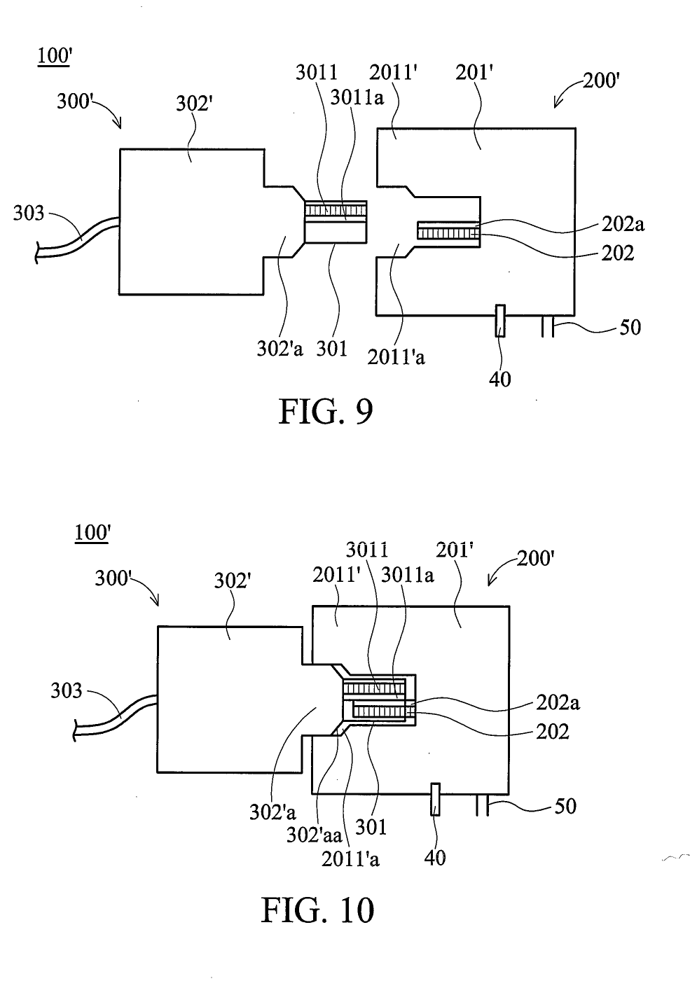

Referring to FIG. 9, most of the structures in a fourth embodiment of a USB connector 100′ are similar to those in the third embodiment, except an insulting portion 302′ of a USB plug 300′ and an insulating case 201′ of a USB socket 200′. The insulating portion 302′ comprises a first extended part 302′a, and the shape of the first extended part 302′a is different from the first extended part 302 in the third embodiment. Furthermore, the shape of a narrow space 2011′a covered by a second extended part 2011′ is different from the second extended part 2011 of the third embodiment.

The front end of the first extended part 302′a comprises a narrow part 302′aa. Furthermore, the shape of the space 2011′a covered by the second extended part 2011′ depends on the shape of the narrow part 302′aa of the first extended part 302′a, thus the narrow part 302′aa is closely connected to the narrow space 2011′a to protect the metallic plug 301 from the external air.

In conclusion, the metallic plug is protected from static discharge in the first to fourth embodiments by utilizing the special structures of the USB plug and the USB socket.

Note that the arrangement and the position of the extended part (211, 321, 2011, 2011′, 302a, and 302′a) and space (211a, 321a, 2011a, and 2011′a) are not limited to those depicted in FIG. 2 to FIG. 10, which can vary depending on requirements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A connector, comprising:
a USB socket; and
a USB plug detachably connected to the USB socket, wherein a closed space is formed by the USB plug and the USB socket when the USB plug is connected to the USB socket.

2. The connector as claimed in claim 1, wherein the USB plug comprises:
a metallic plug electrically connected to the USB socket, comprising a first connecting part; and
an insulating portion covering the metallic plug.

3. The connector as claimed in claim 2, wherein the USB socket comprises:
an insulating case comprising an extended part; and
a second connecting part disposed in the insulating case, wherein when the USB plug is inserted into the USB socket, the first connecting part is engaged with the second connecting part and the extended part abuts against the insulating portion, to form the closed space.

4. The connector as claimed in claim 3, wherein the USB plug further comprises a cable, which is electrically connected to the metallic plug.

5. The connector as claimed in claim 3, wherein the first connecting part and the second connecting part respectively comprise a plurality of metallic contacts, when the first connecting part is engaged with the second connecting part, the metallic contacts of the first connecting part are electrically connected to the metallic contacts of the second connecting part.

6. The connector as claimed in claim 1, wherein the USB plug comprises:
an insulating portion, comprising a extended part; and
a metallic plug disposed in the insulating portion, comprising a first connecting part, wherein the first connecting part is electrically connected to the USB socket.

7. The connector as claimed in claim 6, wherein the USB socket comprises:
an insulating case; and
a second connecting part disposed in the insulating case, wherein when the USB plug is inserted into the USB socket, the first connecting part of the metallic plug is engaged with the second connecting part and the extended part of the insulating portion abuts the insulating case, to form the closed space.

8. The connector as claimed in claim 7, wherein the USB plug further comprises a cable, which is electrically connected to the metallic plug.

9. The connector as claimed in claim 7, wherein the first connecting part and the second connecting part respectively comprise a plurality of metallic contacts, when the first connecting part is engaged with the second part, the metallic contacts of the first connecting part are electrically connected to the metallic contacts of the second connecting part.

10. The connector as claimed in claim 1, wherein the USB plug comprises:
an insulating portion, comprising a first extended part; and
a metallic plug disposed in the insulating portion, comprising a first connecting part, wherein the first connecting part is connected to the USB socket.

11. The connector as claimed in claim 10, wherein the USB socket comprises:
an insulating case comprising a second extended part; and
a second connecting part disposed in the insulating case, wherein when the USB plug is inserted into the USB socket, the first connecting part is engaged with the second connecting part and the first extended part is engaged with the second extended part, to form the closed space.

12. The connector as claimed in claim 11, wherein the first extended part further comprises a narrow part and the second extended part comprises a narrow space, when the USB plug is inserted into the USB socket, the first connecting part is engaged with the second connecting part, and the narrow part of the first connecting part is engaged with the narrow space of the second connecting part.
